(19) United States
(12) Patent Application Publication
(10) Pub. No.: US 2006/0290771 A1
(43) Pub. Date: Dec. 28, 2006

(54) Thermal image forming apparatus

(76) Inventor: Dong-hun Han, Suwon-si (KR)

Correspondence Address: STANZIONE & KIM, LLP, 919 18TH STREET, N.W., SUITE 440, WASHINGTON, DC, 20006, US

(21) Appl. No.: 11/357,142

(22) Filed: Feb. 21, 2006

(30) Foreign Application Priority Data
Jun. 28, 2005 (KR) 2005-56076

(51) Int. Cl. G01D 15/10

(52) U.S. Cl. 347/220

(57) ABSTRACT

A thermal image forming apparatus includes a platen roller, a thermal head facing a lower circumferential surface of the platen roller to form a first printing location and facing an upper circumferential surface of the platen roller to form a second printing location, a conveying part to convey a recording medium such that the recording medium passes through the first and second printing locations, and a guide roller to prevent the recording medium from being bent near the first and second printing locations by supporting the recording medium between the platen roller and the conveying part.

### CROSS-REFERENCE TO RELATED APPLICATIONS

This application claims the benefit under 35 U.S.C. § 119 of Korean Patent Application No. 2005-56076, filed on Jun. 28, 2005, in the Korean Intellectual Property Office, the disclosure of which is incorporated herein in its entirety by reference.

### BACKGROUND OF THE INVENTION

1. Field of the Invention

The present general inventive concept relates to a thermal image forming apparatus, and more particularly, to a thermal image forming apparatus capable of forming images on both sides of a recording medium.

2. Description of the Related Art

FIG. 1 is a schematic sectional view of a conventional thermal image forming apparatus that can print images on both sides of a recording medium. Referring to FIG. 1, the conventional thermal image forming apparatus 10 includes a thermal head 11 facing a recording medium P to apply heat thereto, a platen roller 15 pressing the recording medium P toward the thermal head 11, and a conveying part 20 conveying the recording medium P. In the thermal head 11, a plurality of heating points 13 are arranged on a surface which faces the recording medium P in a width direction of the recording medium P. A circumferential surface of the platen roller 15 is formed of an elastic rubber material. The platen roller 15 is an idle roller that rotates by friction with the recording medium P moving along conveying paths. While the recording medium P passes between the thermal head 11 and the platen roller 15, the heating points 13 are selectively heated to form an image on the recording medium P.

As indicated by a solid line, the thermal head 11 is disposed under the platen roller 15 to form a first printing location 16. When the recording medium P passes through the first printing location 16 along a first conveying path indicated by a solid-line arrow, a first image is formed on a bottom surface of the recording medium P. Also, as indicated by a double dotted line, the thermal head 11 rotates and then is disposed over the platen roller 15 to form a second printing location 17. When the recording medium P passes through the second printing location 17 along a second conveying path indicated by a double-dotted-line arrow, a second image is formed on a top surface of the recording medium P. In order to form an image images on both sides of the recording medium P, the image forming apparatus 10 should cause one recording medium P to move along two different conveying paths. Therefore, it is difficult to align image positions (registration) on the top and bottom surfaces of the recording medium P due to a change of the conveying path from the first conveying path to the second conveying path, and lack of alignment of the image positions results in a poor printing quality.

If the thermal head 11 and the platen roller 15 rotate by 180 degrees around their contacting location, it is possible to print on both sides while conveying the recording medium P along the same conveying path. However, the structure of the image forming apparatus becomes complicated and its volume becomes larger.

### SUMMARY OF THE INVENTION

The present general inventive concept provides a thermal image forming apparatus, in which a recording medium moves along a first conveying path and a second conveying path without being bent near printing locations at which images are formed by heat.

The foregoing and/or other aspects of the present general inventive concept are achieved by providing a thermal image forming apparatus including a platen roller, a thermal head facing a lower circumferential surface of the platen roller to form a first printing location and facing an upper circumferential surface of the platen roller to form a second printing location, a conveying part to convey a recording medium such that the recording medium passes through the first and second printing locations, a guide roller to prevent the recording medium from being bent near the first and second printing locations by supporting the recording medium between the platen roller and the conveying part.

Additional aspects and advantages of the present general inventive concept will be set forth in part in the description which follows and, in part, will be obvious from the description, or may be learned by practice of the general inventive concept.

A diameter of the guide roller may be in a range of 90-110% of a diameter of the platen roller.

A path changing unit to guide the recording medium along conveying paths may be further included between the conveying part and the guide roller.

The rotation centers of the guide roller and the platen roller may be placed on one horizontal line.

The foregoing and/or other aspects of the present general inventive concept are also achieved by providing a thermal image forming apparatus to form images on opposite sides of a recording medium, the apparatus including first and second printing locations to print images on opposite sides of the recording medium, a conveying unit to convey a recording medium from a recording medium storage unit along a first path through the first printing location and along a second path through the second printing location, respectively, and a guide member disposed between the conveying unit and the first and second printing locations to prevent the recording medium from being bent after passing through the first and second printing locations.

The foregoing and/or other aspects of the present general inventive concept are also achieved by providing a thermal image forming apparatus to form images on opposite sides of a recording medium, the apparatus including a platen roller, a thermal head elastically biased in contact with the platen roller to print a first image on one side of the recording medium when the thermal head is at a first printing location, and to print a second image on the other side of the printing medium when the thermal head is at a second printing location, and a rotating structure of the thermal head to move the thermal head between the first and second printing locations and to temporarily separate the thermal head from the platen roller to allow the recording medium to pass therebetween, the rotating structure including a support bracket having two locking grooves, a locking member to lock to one of the two locking grooves of the support bracket corresponding to the thermal head being in the first or second printing position, a rotation cam to be rotated by a motor and to unlock the locking member from the one of the two locking grooves, and a bushing to couple the platen roller, the support bracket, and the rotation cam.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic sectional view of illustrating a conventional thermal image forming apparatus that can print an image images on both sides of a recording medium;

FIGS. 2 and 3 are a perspective view and a sectional view, respectively, of illustrating a thermal image forming apparatus according to an embodiment of the present invention general inventive concept, respectively;

FIG. 4 is a sectional view illustrating an operation of a the thermal image forming apparatus according to the present invention of FIG. 3;

FIG. 5 is a sectional view of illustrating a recording medium used in a thermal image forming apparatus according to an embodiment of the present invention general inventive concept;

FIG. 6 is an exploded perspective view illustrating a rotating structure of a thermal head included in the thermal image forming apparatus of FIG. 3; and

FIGS. 7A through 7I are views illustrating sequential rotating operations the rotating structure of the thermal head in of FIG. 6.

### DETAILED DESCRIPTION OF THE PREFERRED EMBODIMENTS

The present invention will now be described more fully with reference to the accompanying drawings, in which exemplary embodiments of the invention are shown.

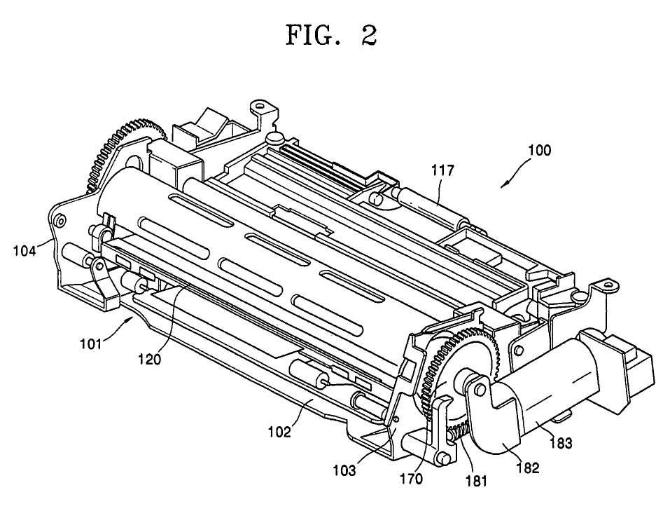

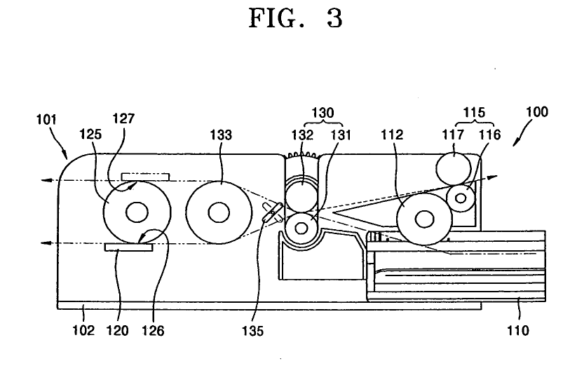

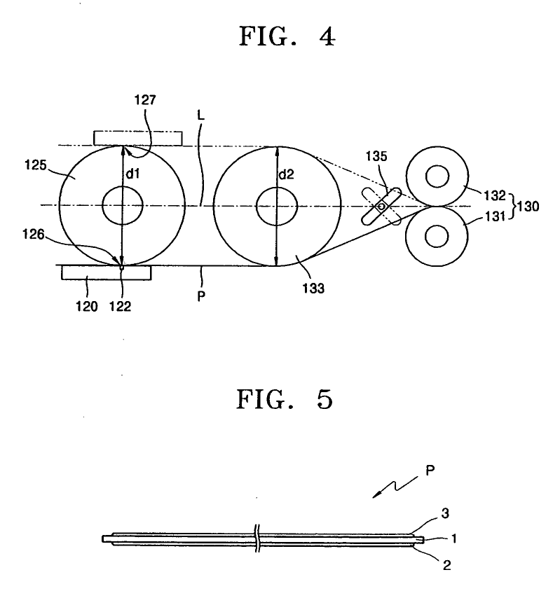

FIGS. 2 and 3 are a perspective view and a sectional view, respectively, of a thermal image forming apparatus 100 according to an embodiment of the present invention general inventive concept, respectively. FIG. 4 is a sectional view of FIG. 3 illustrating an operation of the thermal image forming apparatus, and FIG. 5 is a sectional view illustrating a recording medium used in the thermal image forming apparatus according to an embodiment of the present invention.

Referring to FIGS. 2 through 4, the thermal image forming apparatus 100 includes a frame 101. The frame 101 includes a lower base 102, and two side plates 103 and 104 disposed upright on both opposite sides of the lower base 102. A cassette 110 (see FIG. 3) into which a recording medium P is loaded is mounted on one another side of the frame 101. A pick-up roller 112 for picking to pick up the recording medium P from the cassette 110 is provided at an upper side of the cassette 110. A discharge part 115 for discharging to discharge the printed recording medium P is provided at an upper side of the pick-up roller 112. The discharge part 115 includes a discharge roller 116 and an idle roller 117 engaged therewith. In this the present embodiment, the pick-up roller 112 and the discharge roller 116 comes are in contact with each other and are driven by one drive motor (not shown). The drive motor (not shown) may be coupled to the side plate 104 (see FIG. 2).

A thermal head 120 and a platen roller 125 are provided at a side opposite to the side of the frame 101 where the discharge part 115 and the cassette 110 are located, between the two side plates 103 and 104. The thermal head 120 faces a lower circumferential surface of the platen roller 125 to form a first printing point location 126 and forms an a first image on a bottom surface of the recording medium P passing through the first printing point location 126. Also, the thermal head 120 rotates by 180° degrees around the platen roller 125 to form a second printing point location 127 facing a in contact with an upper circumferential surface of the platen roller 125 and forms an a second image on a top surface of the recording medium P passing through the second printing point location 127. A plurality of heating points 122 are arranged in a length direction of the platen roller 125 on the thermal head 120. The heating points 122 face the platen roller 125 on along the first and second printing points locations 126 and 127. The sectional views of FIGS. 3 and 4 illustrate the first and second printing locations 126 and 127 as point locations, but the plurality of heating points 122 are disposed along directions perpendicular to the sectional views of FIGS. 3 and 4. The heating points 122 are selectively heated to form images when the recording medium P passes between the platen roller 125 and the thermal head 120.

FIG. 5 is a sectional view illustrating a recording medium usable in the thermal image forming apparatus. The recording medium P may have a structure as illustrated in FIG. 5. Color ink layers 2 and 3 are formed on top and bottom surfaces of a base sheet 1 of the recording medium P. Each of the ink layers 2 and 3 may have a single-layer structure for single color or a multi-layer structure for two or more colors. For example, the ink layer 2 formed on the bottom surface may include two stacked layers for yellow and magenta, and the ink layer 3 formed on the top surface may include a single layer for cyan. Since the three primary colors (yellow, magenta and cyan) can come out be recorded by the ink layers 2 and 3, full color images can be represented generated on the recording medium P by forming the base sheet 1 of a transparent material. On the other hand, if the base sheet 1 is formed of an opaque material, the double-sided printing is achieved by forming different images on both surfaces of the recording medium P.

The recording medium P is conveyed by a conveying part 130 (see FIGS. 3 and 4). The conveying part 130 includes a pair of rollers 131 and 132 engaged with each other. One of the pair of rollers is a conveying roller 131 rotating by due to a torque of applied by a drive motor (not shown), and the other is a pinch roller 132 driven by the conveying roller 131.

A guide roller 133 is disposed between the platen roller 125 and the conveying part 130. The guide roller 133 is an idle roller rotating by friction with the recording medium P. The guide roller 133 maintains a good registration an image position of the recording medium P by preventing the recording medium P from being bent near the first and second printing points locations 126 and 127.

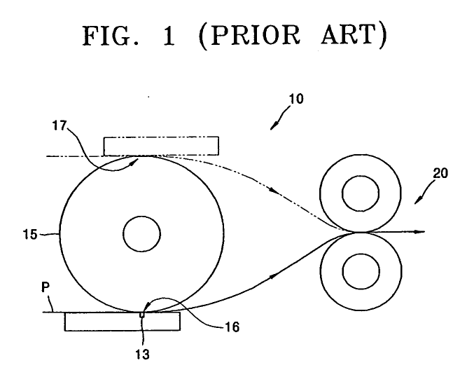

According to the prior art In the conventional thermal image forming apparatus illustrated in FIG. 1, the recording medium P is bent upward suddenly after passing through the first printing point location 16, and is bent downward suddenly after passing through the second printing point location 17. Since the recording medium P is bent in the opposite direction, it is difficult to align registration of positions of images formed on both sides of the recording medium P. However, according to an embodiment of the present invention general inventive concept illustrated in FIG. 4, since the recording medium P moves horizontally without being bent after passing through the first and second printing points locations 126 and 127, registration alignment of the images formed on of both the opposite sides of the recording medium P can be well maintained.

In this the present embodiment, the rotation centers of the guide roller 133 and the platen roller 125 are positioned on one a horizontal line L. Also, a diameter d2 of the guide roller 133 may be 90-110% of a diameter dl of the platen roller 125 so as to prevent the recording medium P from being bent suddenly.

A path changing unit 135 for changing to a conveying path of the recording medium P is disposed between the conveying part 130 and the guide roller 133. The path changing unit 135 may include, for example, a plate or rib coupled to a solenoid (not shown) to rotate clockwise and counterclockwise at by an angle of within a predetermined range.

When a printing instruction is inputted input into to the thermal image forming apparatus 100, the recording medium P loaded in the cassette 110 is picked up by the pickup roller 112. At this time, the path changing unit 135 maintains a location position indicated by a solid line to guide the recording medium P downward, and the recording medium P is disposed between the thermal head 120 and the platen roller 125 indicated by a solid line. When the thermal head 120 closely contacts with the platen roller 125 to form the first printing point location 126, the conveying part 130 pulls and conveys the recording medium P to the discharge part 115. When the recording medium P passes through the first printing point location 126, the heating points 122 selectively emit heat, and then an image is formed on a bottom surface of the recording medium P.

In order for the printing to print on a bottom top surface of the recording medium P, the thermal head 120 rotates by 180 degrees to move over the platen roller 125 to a location as indicated by a double dotted line, and the path changing unit 135 rotates to a location indicated by a double dotted line to guide the recording medium P upward. The recording medium P is fed between the thermal head 120 and the platen roller 125, indicated by a double dotted line, by the conveying part 130. When the thermal head 120 closely contacts with the platen roller 125 again to form a second printing point location 127, the conveying part 130 pulls and conveys the recording medium P to the discharge part 115. When the recording medium P passes through the second printing point location 127, the heating points 122 selectively emit heat and then an image is formed on the top surface of the recording medium P. Then, the printed recording medium P is discharged out of the frame 101 by the discharge part 115.

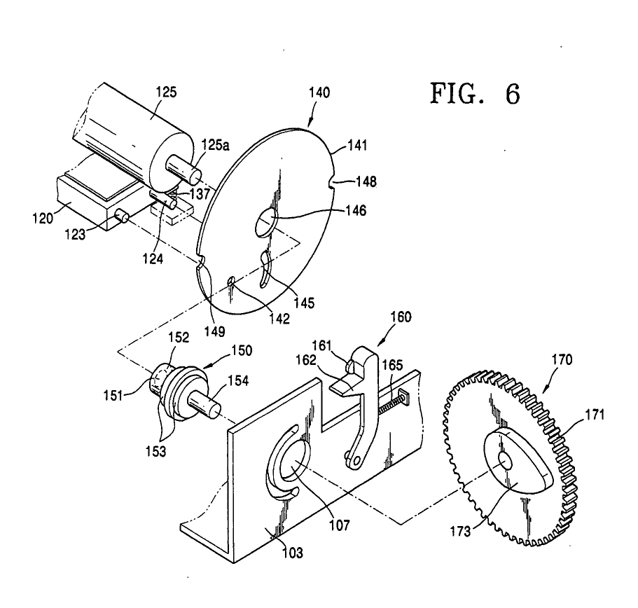

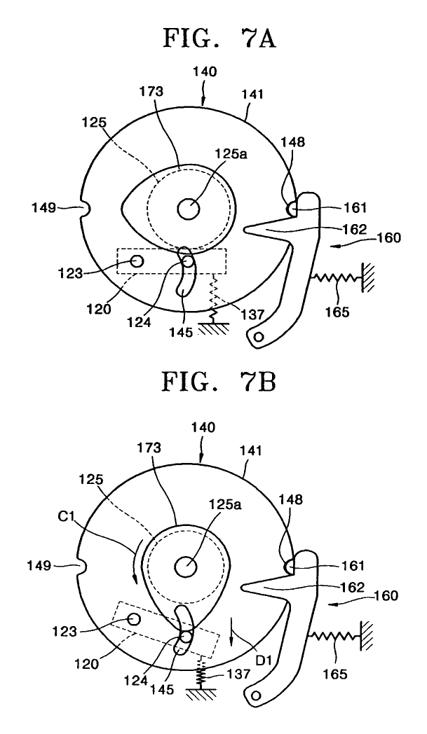

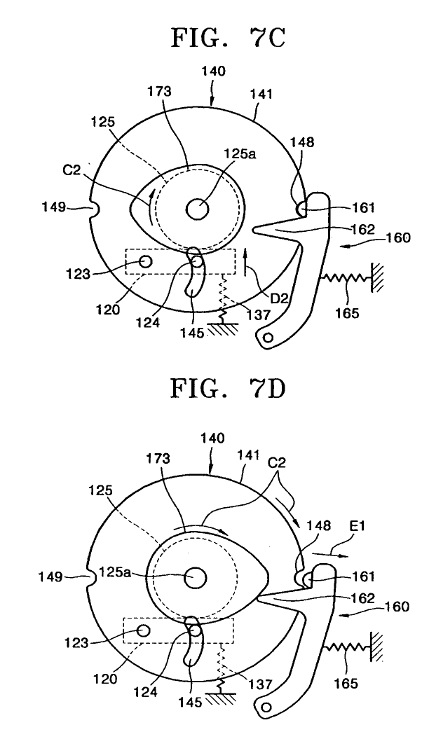

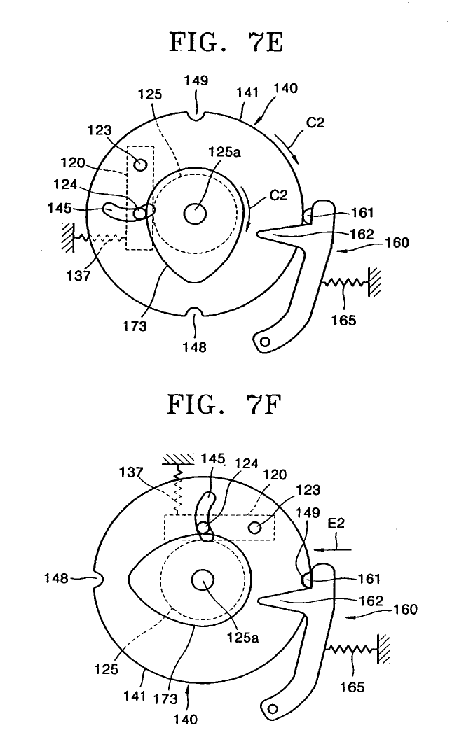

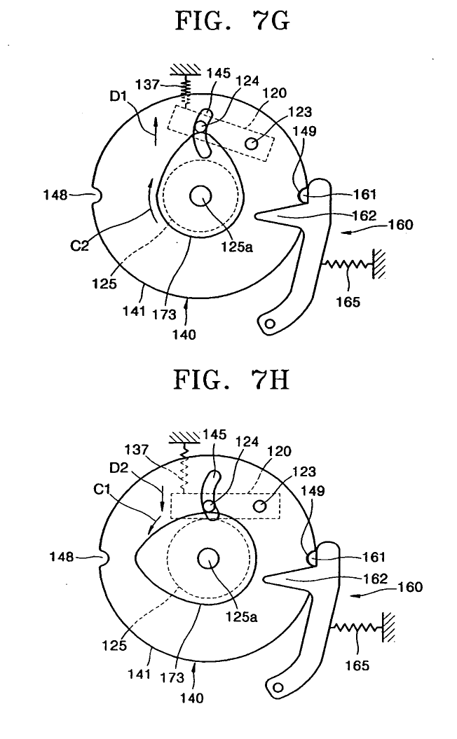

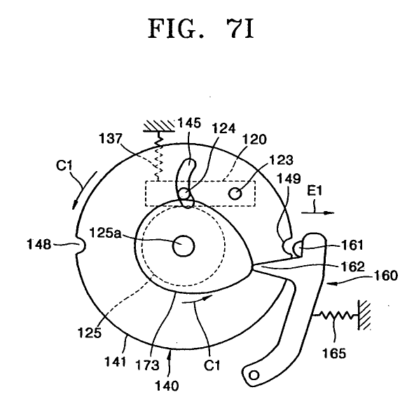

FIG. 6 is an exploded perspective view illustrating a rotating structure of the thermal head 120 included in the thermal image forming apparatus of FIG. 3, and FIGS. 7A through 7I are views illustrating sequential rotating operations of the rotating structure of the thermal head 120 in FIG. 6. Units for Components of the rotating structure of the thermal head 120 will now be described with reference to the drawings.

Referring to FIG. 6, a hinge shaft 123 is disposed at formed on a side portion of the thermal head 120 and a hinge hole 142 is formed at through a support bracket 140. The hinge shaft 123 is inserted into the hinge hole 142 such that the thermal head 120 can rotate around the hinge hole 142 of the support bracket 140. The platen roller 125 thermal head 120 is elastically biased by the a tension coil spring 137 in a direction which comes into contact with towards the thermal head 120 platen roller 125. The tension coil spring 137 has one end coupled to the thermal head 120 and the other end coupled to the platen roller 125 a support.

A protrusion 124 formed on a the same side of the thermal head 120 as the hinge shaft 123 is inserted into a through hole 145 formed at through the support bracket 140. The through hole 145 is formed in a long opening shape so as to allow the thermal head 120 to move in a direction coming into contact with towards the platen roller 125 or in a direction being separated away from the platen roller 125. Also, the through hole 145 may be formed in an arc shape centering on the hinge hole 142, because the thermal head 120 comes into is in contact with the platen roller 125 or it is separated from the platen roller 125 by its rotation rotating around the hinge hole 142.

A bushing 150 includes an inner circumference portion 151, first, second, and third outer circumference portions 152, 153 and 154, which are coaxially formed. A shaft 125a of the platen roller 125 penetrates a support hole 146 formed at a center portion of the support bracket 140 and is inserted into the inner circumference portion 151. The first outer circumference portion 152 is rotatably inserted into the support hole 146 of the support bracket 140. A rotation cam 170 is rotatably coupled to the third outer circumference portion 154. The rotation cam 170 includes a gear 171 of on a circumferential surface and a cam 173, which comes into is in contact with the protrusion 124 of the thermal head 120.

The gear 171 of the rotation cam 170 is engaged with a worm gear 181 (refer to FIG. 2). The worm gear 181 is coupled to a motor (not shown) installed inside a motor housing 183 (refer to FIG. 2) of the frame 101 (refer to FIG. 2). Accordingly, the rotation cam 170 rotates by the motor. The second outer circumference portion 153 of the bushing 150 is inserted into a hole 107 formed through the side plate 103 of the frame 101. A support member 182 (refer to FIG. 2) supports the rotation cam 170 so as not to be decoupled from the third outer circumference portion 154. In the rotating structure of the thermal head 120 as described above, the platen roller 125, the support bracket 140 and the rotation cam 170 can be configured to be concentric.

The support bracket 140 has a circular outer circumference 141, and first and second locking grooves 148 and 149 are formed on the outer circumference 141 at 180° therebetween. A locking member 160 is rotatably coupled to the side plate 103. The locking member 160 is elastically biased by a spring 165 in a direction towards the outer circumference 141 of the support bracket 140. The locking member 160 is unlocked from the first or second locking grooves 148 and 149 by the rotation cam 170 and is locked thereto by the elastic force of the spring 165. The locking member 160 has a locking protrusion 161 to be locked in the first and second locking grooves 148 and 149, and an interference portion 162 that interferes with the cam 173 of the rotation cam 170 when the cam 173 rotates.

Referring to FIG. 7A, the thermal head 120 is brought into contact with the platen roller 125 by pressure of the tension coil spring 137 before starting the printing operation. Also, the locking protrusion 161 of the locking member 160 is becomes locked by the first locking groove 148, such that the thermal head 120 is positioned at a first location at a lower side of the platen roller 125.

In order to print, the thermal head 120 is separated from the platen roller 125. Referring to FIG. 7B, the rotation cam 170 driven by the motor (not shown) rotates in a direction indicated by an arrow “C1” and the cam 173 pushes the protrusion 124 of the thermal head 120 in a direction indicated by an arrow “D1.” The support bracket 140 does not rotate because the locking protrusion 161 of the locking member 160 is locked to the first locking groove 148. As the protrusion 124 is pushed along the through hole 145 in a direction indicated by the arrow “D1,” the thermal head 120 rotates around the hinge shaft 123, such that the thermal head 120 is separated from the platen roller 125. While the thermal head 120 is not in contact with the platen roller 125, the recording medium P is fed and guided between the thermal head 120 and the platen roller 125.

Referring to FIG. 7C, the rotation cam 170 rotates in a direction indicated by an arrow “C2” by the motor (not shown). Since the locking protrusion 161 of the locking member 160 is locked in the first locking groove 148, the support bracket 140 does not rotate. Due to the elastic force of the tension coil spring 137, the thermal head 120 rotates around the hinge shaft 123 in a direction indicated by an arrow “D2,” such that the thermal head 120 elastically contacts the platen roller 125. While the thermal head 120 is in contact with the platen roller 125, the recording medium P is conveyed in a first direction opposite to a first feeding direction, and a first image is formed on a bottom surface of the recording medium P by heat emitted from the thermal head 120.

Referring to FIG. 7D, when the rotation cam 170 rotates in a direction indicated by the arrow “C2,” and the cam 173 pushes the interference portion 162 such that the locking member 160 rotates in a direction indicated by an arrow “E1,” the locking protrusion 161 is unlocked from the first locking groove 148, and the support bracket 140 becomes rotatable. Accordingly, when the cam 173 continuously rotates in the direction indicated by the arrow “C2” and thus the cam 173 pushes the protrusion 124 of the thermal head 120, the support bracket 140 rotates in a direction indicated by the arrow “C2,” as illustrated in FIG. 7E, rather than the thermal head 120moving away from the plate roller 125. Also, since the thermal head 120 and the platen roller 125 are coupled to the support bracket 140, they rotate with the support bracket 140.

Referring to FIG. 7F, if the support bracket 140 rotates by 180°, the elastic force of the spring 165 causes the locking member 160 to rotate in a direction indicated by an arrow “E2,” such that the locking protrusion 161 is locked to the second locking groove 149. Also, the support bracket 140 is locked and thus it does not rotate. In this state, the thermal head 120 faces an upper side of an outer circumferential surface of the platen roller 125. In FIG. 7F, the thermal head 120 is positioned in a second location at an upper side of the platen roller 125.

Since the locking protrusion 161 is locked to the second locking groove 149, the support bracket 140 does not rotate although the rotation cam 170 continues to rotate in a direction indicated by the arrow “C2.” However, as illustrated in FIG. 7G as the protrusion 124 of the thermal head 120 is pushed along the through hole 145 by the cam 173, the thermal head 120 is separated from the platen roller 125.

While the thermal head 120 is not in contact with the platen roller 125, the recording medium P is fed between the platen roller 125 and the thermal head 120. If the rotation cam 170 rotates in a direction indicated by the arrow “C1,” the support bracket 140 does not rotate because the locking protrusion 161 is locked to the second locking groove 149. However, the protrusion 124 of the thermal head 120 moves along the through hole 145 as illustrated in FIG. 7H, and the thermal head 120 is brought back in contact with the platen roller 125. While the thermal head 120 is in contact with the platen roller 125, the recording medium P is conveyed in a second direction opposite to a second feeding direction, a second image is formed on a top surface of the recording medium P by heat emitted from the thermal head 120. The first and second feeding directions are essentially parallel to each other in the lower and upper part of the platen roller 125.

Referring to FIG. 7I, when the printing operation is completed, the rotation cam 170 rotates in a direction indicated by the arrow “C1.” The cam 173 pushes the interference portion 162 such that the locking member 160 rotates in a direction indicated by the arrow “E1.” In that case, the locking protrusion 161 is separated from the second locking groove 149, and the support bracket 140 is unlocked. If the cam 173 continuously rotates and pushes the protrusion 124 of the thermal head 120, the support bracket 140 rotates until the locking protrusion 161 is locked in the first locking groove 148 by the elastic force of the spring 165. When the locking protrusion 161 becomes locked in the first locking groove 148, the thermal head 120 returns back to the first location, as illustrated in FIG. 7A. If another printing instruction is received, the thermal head 120 can get ready for a next printing operation by separating from the platen roller 125, as illustrated in FIG. 7B.

As described above, a thermal image forming apparatus according various embodiments of the present general inventive concept includes a guide roller to prevent a recording medium from being bent near printing locations, and thus to make easy to align positions of images formed on both sides of the recording medium. Consequently, poor printing quality due to a poor alignment can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A thermal image forming apparatus, comprising:
a platen roller;
a thermal head facing a lower circumferential surface of the platen roller to form a first printing location, and an upper circumferential surface of the platen roller to form a second printing location;
a conveying part to convey a recording medium such that the recording medium passes through the first and second printing locations; and
a guide roller to prevent the recording medium from being bent near the first and second printing locations by supporting the recording medium between the platen roller and the conveying part.

2. The apparatus of claim 1, wherein a diameter of the guide roller is in a range approximately 90-110% of a diameter of the platen roller.

3. The apparatus of claim 1, further comprising:
a path changing unit to guide the recording medium along conveying paths between the conveying part and the guide roller.

4. The apparatus of claim 1, wherein rotation centers of the guide roller and the platen roller are placed on a horizontal line.

5. A thermal image forming apparatus to form images on opposite sides of a recording medium, the apparatus comprising:
first and second printing locations to print images on opposite sides of the recording medium;
a conveying unit to convey a recording medium from a recording medium storage unit along a first path through the first printing location and along a second path through the second printing location, respectively;
a guide member disposed between the conveying unit and the first and second printing locations to prevent the recording medium from being bent after passing through the first and second printing locations.

6. The apparatus of claim 5, wherein the conveying unit conveys the recording medium in a first direction from the recording medium storage unit along the first path passing through the first printing location, a second direction opposite to the first direction and along the first printing path, a third direction along the second path passing through the second printing location, and a fourth direction opposite to the third direction and along the second printing path.

7. The apparatus of claim 6, wherein the images are printed on the recording medium when the recording medium is conveyed in the second direction along the second printing path and in the fourth direction along the second printing path, respectively.

8. The apparatus of claim 5, wherein the first and second printing locations are within respective substantially parallel planes having a first distance therebetween, and the guide member is a roller having a diameter approximately 90-110% of the first distance.

9. The apparatus of claim 5, wherein a rotation center of the guide member is placed on a horizontal line equidistant from the first and second printing locations.

10. The apparatus of claim 5, wherein the conveying unit further comprises:
a path changing unit disposed where the first path separates from the second path to guide the recording medium towards one of the first and second paths.

11. The apparatus of claim 10, wherein the path changing unit comprises:
a plate to rotate clockwise and counterclockwise by an angle within a predetermined range.

12. The apparatus of claim 11, wherein rotation centers of the guide member and the plate are placed on a horizontal line equidistant from the first and second printing locations.

13. The apparatus of claim 5, further comprising:
a platen roller;
a thermal head elastically biased in contact with the platen roller to print images on one side of a recording medium when the thermal head is at the first printing location, and on the other side of the printing medium when the thermal head is at the second printing location; and
a rotating structure to move the thermal head between the first and second printing locations and to temporarily separate the thermal head from the platen roller to allow the recording medium to pass therebetween.

14. The apparatus of claim 13, wherein the rotating structure comprises:
a support bracket having two locking grooves;
a locking member to lock to one of the two locking grooves of the support bracket corresponding to the thermal head being in the first or second printing position;
a rotation cam to be rotated by a motor and to unlock the locking member from the one of the two locking grooves; and
a bushing to couple the platen roller, the support bracket, and the rotation cam.

15. A thermal image forming apparatus to form images on opposite sides of a recording medium, the apparatus comprising:
a platen roller;
a thermal head elastically biased in contact with the platen roller to print a first image on one side of the recording medium when the thermal head is at a first printing location, and to print a second image on the other side of the printing medium when the thermal head is at a second printing location; and
a rotating structure of the thermal head to move the thermal head between the first and second printing locations and to temporarily separate the thermal head from the platen roller to allow the recording medium to pass therebetween, the rotating structure comprising:
a support bracket having two locking grooves;
a locking member to lock to one of the two locking grooves of the support bracket corresponding to the thermal head being in the first or second printing position;
a rotation cam to be rotated by a motor and to unlock the locking member from the one of the two locking grooves; and
a bushing to couple the platen roller, the support bracket, and the rotation cam.

16. The apparatus of claim 15, further comprising:
a first spring to elastically bias the thermal head towards the platen roller; and
a second spring to elastically bias the locking member towards the support bracket.

17. The apparatus of claim 15, wherein the locking member is biased in a first direction towards the support bracket and comprises:
a locking protrusion to lock to one of the two grooves of the support bracket; and
an interference portion that is pushed in a second direction opposite to the first direction by the rotation cam to unlock the locking protrusion from the one of the two grooves of the support bracket.

18. The apparatus of claim 15, wherein during a printing operation the thermal head is moved by the rotating structure in a first position at the first printing location in contact with the platen roller, the thermal head is then rotated in a second position separated from the platen roller so that a recording medium passes therebetween, the thermal head is then released back in the first position and the thermal head prints the first image on the recording medium conveyed between the thermal printhead and the platen roller, the thermal head is then moved by the rotating structure to a third position at the second printing location in contact with the platen roller, the thermal head is then rotated in a fourth position separated from the platen roller so that the recording medium passes therebetween, the thermal head is then released to the third position and prints the second image on the recording medium.

19. The apparatus of claim 18, wherein the support bracket rotates with the rotating cam when the thermal head is moved between the first position at the first printing location and the third position at the second printing location.
